(19) United States
(12) Patent Application Publication
(10) Pub. No.: US 2025/0116432 A1
(43) Pub. Date: Apr. 10, 2025

(54) MODIFIED BRAYTON REFRIGERATION CYCLES FOR FORCED-FLOW COOLING OF HTS FUSION SYSTEM

(71) Applicant: HONGIK UNIVERSITY INDUSTRY-ACADEMIA COOPERATION FOUNDATION, Seoul (KR)

(72) Inventors: Ho Myung CHANG, Seoul (KR); Yu Mi CHA, Seoul (KR)

(73) Assignee: HONGIK UNIVERSITY INDUSTRY-ACADEMIA COOPERATION FOUNDATION, Seoul (KR)

(21) Appl. No.: 18/907,177

(22) Filed: Oct. 4, 2024

(30) Foreign Application Priority Data
Oct. 6, 2023 (KR) 10-2023-0133748

(51) Int. Cl. F25B 9/14; F25B 9/00; F25B 9/06; G21B 1/11

(52) U.S. Cl. CPC F25B 9/14; F25B 9/002; F25B 9/06; G21B 1/11

(57) ABSTRACT

A thermodynamic study is performed to identify suitable refrigeration cycles for emerging application to a high-temperature superconductor (HTS) fusion system. According to recent reports on a compact and efficient fusion system, HTS magnets are supposed to operate at about 20 K by forced-flow cooling of helium gas. In addition to the main cryogenic load for the magnets, there are other cooling requirements, including the refrigeration of a thermal shield and current leads. In order to compose a closed refrigeration system without liquid-nitrogen supply or any boil-off loss, modified Brayton cycles are designed to cover the cooling loads with a circulation loop of a coolant for the magnets, the thermal shield, and the current leads. Innovative design is also proposed to integrate the cooling loop with the refrigeration cycle, as helium gas is used as a coolant and a refrigerant.

This application claims the benefit of Korean Patent Application No. 10-2023-0133748, filed on Oct. 6, 2023, which is hereby incorporated by reference as if fully set forth herein.

### STATEMENT REGARDING PRIOR DISCLOSURES BY THE INVENTOR OR A JOINT INVENTOR

Applicant hereby states under 37 CFR 1.77(b)(6) that Chang et al., “Modified Brayton refrigeration cycles for forced-flow cooling of HTS fusion system”, Cryogenics, Volume 132, published on Apr. 14, 2023, is designated as a grace period inventor disclosure. The disclosure: (1) was made one year or less before the effective filing date of the claimed invention; (2) names the inventor or a joint inventor as an author; and (3) does not name additional persons as authors on a printed publication.

### BACKGROUND OF THE INVENTION

### Field of the Invention

The present invention relates to modified Brayton refrigeration cycles for forced-flow cooling of a high-temperature superconductor (HTS) fusion system, and more particularly to an integrated cooling cycle that simultaneously and efficiently cools HTS magnets, a thermal shield, and current leads by using gaseous helium as a refrigerant and a coolant at the same time.

### Discussion of the Related Art

Nuclear fusion power generation with high-temperature superconductor (HTS) magnets is a valuable effort to realize clean energy. Since an HTS is capable of carrying more current at higher temperatures than a low-temperature superconductor (LTS), an HTS fusion system is expected to be compact in size and efficient in cryogenic refrigeration, when compared with an international thermonuclear experimental reactor (ITER) or other LTS tokamak systems. The remarkable progress of second-generation rare-earth barium copper oxide (REBCO) wire materials has provided a realistic prospect of HTS fusion magnets along with proper cooling schemes.

According to the leading groups, the operating temperature of HTS fusion magnets should be in the range of 10 to 30 K for compactness and efficiency. Cryogenic cooling at this temperature is far different from existing 4 to 5 K cooling, because liquid helium cannot be used, but the forced-flow of gaseous helium is required. In order to meet the requirement of large-scale refrigeration (over 10 kW) at about 20 K, modified Brayton cycles, which have been effectively used for the sub-cooling of liquid hydrogen in target moderators at the European Spallation Source, could be a reasonable choice.

In addition to the main refrigeration load for the cold body with HTS magnets, there are other cooling requirements, including a thermal shield and current leads. Liquid nitrogen has been widely used for the cooling of the thermal shield and the current leads in large-scale cryogenic systems. The refrigeration load of superconducting magnets is significantly reduced by the thermal shield at liquid-nitrogen temperature. For high-field superconducting magnets, it is a common practice to employ binary HTS leads (a serial combination of an HTS conductor as a cold part and a metallic conductor as a warm part). In most cases of high-current leads (over 10 kA), the joint part of an HTS and a metal is cooled by liquid nitrogen, and the boil-off gas flows up for convective cooling of the metallic conductor. Lately, however, a number of design efforts have been made towards the forced-flow cooling of the thermal shield and the current leads, enabling the operation without any supply of liquid nitrogen or the boil-off loss. For continuous gas-cooling with a circulation loop, modified Brayton refrigeration cycles may be a viable option as well.

### PRIOR ART DOCUMENT

[Patent Document] Korean Registered Patent Publication No. 10-1761378 (registered on Jul. 19, 2017)

### SUMMARY OF THE INVENTION

It is an object of the present invention to identify suitable refrigeration cycles for forced-flow cooling of HTS fusion systems and to seek the optimal operation conditions for efficient refrigeration. Specifically, standard and modified Brayton cycles are investigated in conjunction with a circulation loop of forced-flow. Since gaseous helium is used as a refrigerant (working fluid) and a coolant (cooling gas) at the same time, an integrated design of the refrigeration cycle and the circulation loop is proposed in the present invention for easy and simple operation without any cryogenic pump or blower for forced-flow. In addition to an evident merit in operation, integrated cycles have a potential advantage in thermodynamic efficiency as well, because entropy generation due to the temperature difference between the refrigerant and the coolant may be eliminated. The present invention proposes an integrated cooling cycle for each of three requirements (HTS magnets, a thermal shield, and current leads) and finally a fully integrated cooling cycle that satisfies all the requirements.

In accordance with the present invention, the above and other objects can be accomplished by the provision of an integrated refrigeration cycle for forced-flow cooling of an HTS fusion system, the integrated refrigeration cycle including a compressor configured to compress a refrigerant, an after-cooler configured to cool the compressed refrigerant, a first heat exchanger configured to perform heat exchange between the high-pressure refrigerant that has passed through the after-cooler and the low-pressure refrigerant before passing through the compressor, a first expander configured to expand the refrigerant that has passed through the first heat exchanger and to send the same to an internal flow path of a thermal shield, a second heat exchanger configured to perform heat exchange between the high-pressure refrigerant that has passed through the first heat exchanger and the low-pressure refrigerant, a third heat exchanger configured to perform heat exchange between the high-pressure refrigerant that has passed through the second heat exchanger and the low-pressure refrigerant, a second expander configured to expand the refrigerant that has passed through the third heat exchanger, a third expander configured to expand the refrigerant expanded by the second expander and to send the same to a flow path in contact with a current lead, a fourth heat exchanger configured to perform heat exchange between the refrigerant expanded by the second expander and the low-pressure refrigerant, a fourth expander configured to expand the refrigerant that has passed through the fourth heat exchanger, an HTS magnet configured to allow the refrigerant expanded by the fourth expander to pass through an internal flow path thereof so as to be cooled to a cryogenic temperature, a thermal shield configured to allow the refrigerant expanded by the first expander to pass through an internal flow path thereof so as to be cooled to the cryogenic temperature, and a current lead configured to allow the refrigerant expanded by the third expander to pass through an external flow path in contact with surroundings thereof so as to be cooled.

Helium gas may be used as the refrigerant and a coolant at the same time.

The refrigerant that has passed through the internal flow path of the HTS magnet may sequentially pass through the fourth heat exchanger, the third heat exchanger, the second heat exchanger, and the first heat exchanger on a low-pressure refrigerant flow path.

A flow path of the refrigerant that has passed through the internal flow path of the thermal shield may be connected to a flow path before passing through the second heat exchanger on the low-pressure refrigerant flow path.

The refrigerant flow path in contact with the current lead may be disposed so as to wrap around the current lead and may be connected to the compressor such that the refrigerant is introduced into the compressor.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic view showing a refrigeration system for forced-flow cooling of magnets M, a thermal shield TS, and current leads CL in an HTS fusion system according to an embodiment of the present invention;

FIG. 2 is a view showing six different refrigeration cycles for forced-flow cooling of HTS magnets;

FIG. 3 is a graph showing the figure of merit (FOM) as a function of the intermediate pressure P₄ for selected values of the low pressure P₁ and the inlet temperature Ti in cycle M2;

FIG. 4 is a graph showing the FOM as a function of inlet temperature for various values of high pressure in cycle M6;

FIG. 5 shows the temperature-entropy diagram and the exergy expenditure for six optimized M cycles;

FIG. 6 shows a separate cycle TS1 and an integrated cycle TS2 for forced-flow cooling of the thermal shield;

FIG. 7 shows the temperature-entropy diagram and the exergy expenditure for optimized cycles TS1 and TS2;

FIG. 8 shows separate cycles CL1 and CL2 and an integrated cycle CL3 for forced-flow cooling of the current leads;

FIG. 9 shows the temperature-entropy diagram and the exergy expenditure for optimized cycles CL1, CL2, and CL3;

FIG. 10 shows a fully integrated cycle F for forced-flow cooling of the magnets, the thermal shield, and the current leads;

FIG. 11 is a graph showing the FOM as a function of the low pressure P₁ for various values of the high pressure P₂ in cycle F; and

FIG. 12 shows the temperature-entropy diagram, the exergy expenditure, and the table of temperature, pressure, and flow rate at each point of optimized cycle F.

### DETAILED DESCRIPTION OF THE INVENTION

The present invention may be variously changed and may have several embodiments, and therefore specific embodiments will be described in detail while being illustrated in the drawings. However, the present invention is not limited to the specific embodiments, and it should be understood that the present invention includes all alterations, equivalents, and substitutions falling within the idea and technical scope of the present invention.

The terms used in the present invention are used only to describe a specific embodiment, not to define the present invention. Singular forms include plural forms unless mentioned otherwise. It should be understood that the terms “comprises,” “has,” etc. specify the presence of stated features, numbers, steps, operations, elements, components, or combinations thereof described in this specification, but do not preclude the presence or addition of one or more other features, numbers, steps, operations, elements, components, or combinations thereof.

Hereinafter, preferred embodiments of the present invention will be described in detail with reference to the accompanying drawings. Here, it is noted that, in the accompanying drawings, identical components are denoted by the same reference symbols wherever possible. In addition, detailed descriptions of known features and configurations that may obscure the gist of the present invention will be omitted. For the same reason, in the accompanying drawings, some components are exaggerated, omitted, or shown schematically.

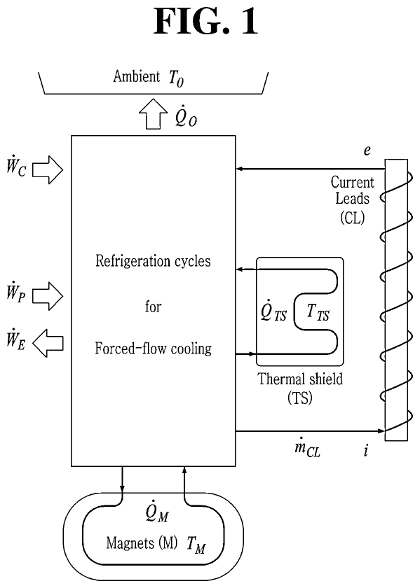

FIG. 1 is a schematic view showing a refrigeration system for forced-flow cooling of magnets M, a thermal shield TS, and current leads CL in an HTS fusion system according to an embodiment of the present invention.

A control volume is considered around the refrigeration cycles for forced-flow cooling, as schematically shown in FIG. 1 The system includes the refrigeration cycles and the circulation loops, but excludes the magnets M, the thermal shield TS, and the current leads CL with spiral cooling channel. At steady state, the energy and entropy balance equations for the control volume are written as follows:

$$( {\dot{W}}_{C} + {\dot{W}}_{P} - {\dot{W}}_{E} ) - {\dot{Q}}_{0} + {\dot{Q}}_{M} + {\dot{Q}}_{TS} - {\dot{m}}_{CL} ( {h}_{i} - {h}_{e} ) = 0 \qquad [ Equation 1 ]$$

$$- \frac{{\dot{Q}}_{0}}{{T}_{0}} + \frac{{\dot{Q}}_{M}}{{T}_{M}} + \frac{{\dot{Q}}_{TS}}{{T}_{TS}} = {\dot{m}}_{CL} ( {s}_{i} - {s}_{e} ) + {\dot{S}}_{gen} = 0 \qquad [ Equation 2 ]$$

where \dot{W}_{C}, \dot{W}_{P}, and \dot{W}_{E} are the input power to compressors C and circulation pumps P, and the output power from expanders E, respectively. \dot{Q}₀ is the heat rejected to ambient at T₀, and \dot{Q}_{M} and \dot{Q}_{TS} are the thermal loads of the magnets at T_{M} and the thermal shield at T_{TS}, respectively. Even though temperature may not be spatially uniform in practice, T_{M} and T_{TS} may be simply taken as the design temperature (i.e. the highest allowable temperature). \dot{m}_{CL} is the mass flow rate of cooling gas for the current leads, and h and s are the specific enthalpy and the specific entropy of helium, respectively. The subscripts i and e denote the inlet and exit of forced-flow cooling, respectively.

By combining Equation 1 and Equation 2, the net input power may be derived as follows:

$${\dot{W}}_{C} + {\dot{W}}_{P} - {\dot{W}}_{E} = {\dot{Q}}_{M} ( \frac{{T}_{0}}{{T}_{M}} - 1 ) + {\dot{Q}}_{TS} ( \frac{{T}_{0}}{{T}_{TS}} - 1 ) + {\dot{m}}_{CL} [ ( {h}_{i} - {h}_{e} ) - {T}_{0} ( {s}_{i} - {s}_{e} ) ] + {T}_{0} {\dot{S}}_{gen} = {( {\dot{W}}_{rev} )}_{M} + {( {\dot{W}}_{rev} )}_{TS} + {( {\dot{W}}_{rev} )}_{CL} + {T}_{0} {\dot{S}}_{gen} \qquad [ Equation 3 ]$$

where the first three terms on the right-hand side are the reversible power for refrigeration of M, TS, and CL, respectively, and the last term is the additional power due to entropy generation. The total entropy generation may be expressed as the sum of entropy generation at all components of the system.

$${\dot{S}}_{gen} = {( {\dot{S}}_{gen} )}_{C} + {( {\dot{S}}_{gen} )}_{AC} + {( {\dot{S}}_{gen} )}_{HX} + {( {\dot{S}}_{gen} )}_{E} + {( {\dot{S}}_{gen} )}_{P} + {( {\dot{S}}_{gen} )}_{MIX} + {( {\dot{S}}_{gen} )}_{M} + {( {\dot{S}}_{gen} )}_{TS} + {( {\dot{S}}_{gen} )}_{CL} \qquad [ Equation 4 ]$$

where the subscripts AC, HX, and MIX denote after-coolers, heat exchangers, and mixing, respectively. The last three terms in Equation 4 are the entropy generation of forced-flow cooling for M, TS, and CL, respectively.

The thermodynamic performance of the refrigeration system is evaluated by the figure of merit (FOM) or the second-law effectiveness, which is defined as follows:

$$FOM = \frac{{\dot{W}}_{rev}}{{\dot{W}}_{C} + {\dot{W}}_{P} - {\dot{W}}_{E}} \qquad [ Equation 5 ]$$

The objective of thermodynamic optimization is to maximize the FOM or to minimize the entropy generation. The deficiency of FOM (=1-FOM) may be itemized by the contribution by all components from Equation 3 and Equation 4, as will be illustrated with a pie chart (called the “exergy expenditure”) for each cycle in the following.

The assumptions below are made for simplicity and quantitative discussion.

\textcircled{1} The ambient (0) temperature and the exit temperature of all after-coolers AC are 300 K.

\textcircled{2} The adiabatic efficiency is 80% for all compressors C, expanders E, and circulating pumps P.

\textcircled{3} The compression is performed in a multi-stage manner with the after-coolers, and the pressure ratio is the same (1.5 to 2.0) for each stage.

\textcircled{4} The minimum temperature approach is 1.5% of the absolute temperature of hot stream in all heat exchangers.

\textcircled{5} The pressure drop is 10 kPa for each stream of all heat exchangers.

\textcircled{6} In all cycles, the lower and upper limits of pressure are 100 kPa and 2 MPa, respectively.

Assumptions \textcircled{3} and \textcircled{3} are made for a rough estimation of the compressor work, even though the adiabatic efficiency and the pressure ratio may be different to an extent, depending on the type of compressors in practice. Assumption \textcircled{4} is made by the well-known optimization theory on counter-flow heat exchangers in cryogenic refrigeration, and the value 1.5% is set for comparison with a previous report on large-scale Brayton refrigeration cycles at 20 K. Assumption \textcircled{5} is an over-simplified one only for the purpose of short comparison between similar cycles. The pressure drop should be carefully estimated for detailed process design, taking into consideration the fluid flow and dimensional factors in the heat exchangers. The upper limit in assumption \textcircled{6} is also set from the reports on helium refrigeration systems.

For demonstration in the following sections, a set of refrigeration requirements for forced-flow cooling are selected, as listed in Table 1. The specified temperatures are of utmost importance to the present invention, while the thermal loads are roughly estimated from the recent publications on HTS fusion magnets with reference to ITER and other existing tokamak systems. It should be noted that the cooling load is prescribed at T_{M} and T_{TS} for M and TS, respectively, but the flow rate of cooling gas is prescribed with inlet and exit temperatures Tᵢ and Tₑ for CL. Strictly speaking, the refrigeration requirement of CL should be prescribed by the number of pairs with the respective current levels (for example, 18 pairs of 30 kA leads for TF coils and 24 pairs of 20 kA leads of PF and CS coils). The design of such gas-cooled leads includes elaborated optimization for the dimensional size of the conductor and the cooling-gas conditions. The cooling requirement of CL in Table 1 is regarded as a simple example of optimized results for this thermodynamic study. General-purpose process simulator (Aspen HYSYS) with real-gas properties of helium (REFPROP) is used for cycle analysis and optimization.

TABLE 1

| | | | | |
|---|---|---|---|---|
| HTS magnets | Magnet temperature | T_{M} | 20 | K |
| (M) | Cooling load | | 25 | kW |
| | Inlet pressure | P [symbol] | 600 | kPa |
| | Pressure drop | P [symbol] -P [symbol] | 100 | kPa |
| Thermal | Shield temperature | T_{TS} | 100 | K |
| shield | Cooling load | | 75 | kW |
| (TS) | Inlet pressure | P [symbol] | 530 | kPa |
| | Pressure drop | P [symbol] -P [symbol] | 100 | kPa |
| Current leads | Inlet temperature | T [symbol] | 50 | K |
| (CL) | Exit temperature | T [symbol] | 295 | K |
| | Mass flow rate | | 0.2 | kg/s |
| | Inlet pressure | P [symbol] | 400 | kPa |
| | Pressure drop | P [symbol] -P [symbol] | 100 | kPa |

[symbol]

indicates data missing or illegible when filed

### [Forced-Flow Cooling of HTS Magnets]

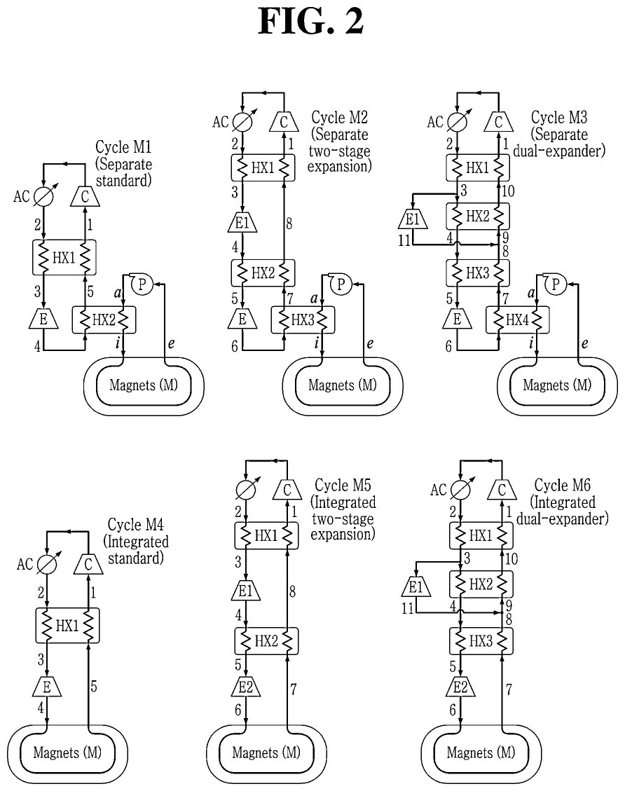

FIG. 2 shows six different refrigeration cycles for forced-flow cooling of HTS magnets M. In every case, helium is the refrigerant and also the coolant of the circulation loop. Cycle M1 is the simple case of standard Brayton cycle with a cryogenic expander E and a counter-flow heat exchanger HX2 at a cold end. A circulating pump P or cryogenic blower drives the forced-flow against the pressure drop of the circulating loop. The thermal load from the magnets is delivered to the refrigeration cycle at HX2. The input power for refrigeration may be significantly reduced by modifying the cycle with two expanders, as shown in cycles M2 or M3. In the modified cycles, the two expanders may be arranged in series (M2) or in parallel (M3), referred to as a “two-stage expansion” cycle or a “dual-expander” cycle, respectively. The cold end configuration is the same for all three cycles M1, M2, and M3. In practice, the circulating pump may be placed at ambient temperature with a recuperative heat exchanger for easy and stable operation. Warm circulation cycles are not considered in this thermodynamic study, because they are obviously less efficient than the corresponding cold circulation cycles (due to the additional entropy generation in the heat exchanger) and the thermodynamic optimization of main refrigeration cycles should be the same, regardless of the pump temperature.

Innovative design is proposed in the present invention to integrate the circulation loop with the refrigeration cycle. Cycles M4, M5, and M6 are the integrated versions of cycles M1, M2, and M3, respectively. An obvious merit of the integrated cycles is to eliminate the circulating pump P and the cold-end heat exchanger HX2. Instead of the pump at cryogenic temperature, the compressors at ambient temperature are responsible for the forced flow with some additional power. Since a reduction in input power is expected as well, the quantitative comparison of the FOM for separate and integrated cycles is therefore a significant issue in the present invention.

From Equation 3 and Equation 5, the FOM of M cycles is simply expressed as follows:

$${FOM}_{M} = \frac{{( {\dot{W}}_{rev} )}_{M}}{{\dot{W}}_{C} + {\dot{W}}_{P} - {\dot{W}}_{E}} = \frac{{\dot{Q}}_{M} ( {T}_{0} / {T}_{M} - 1 )}{{\dot{W}}_{C} + {\dot{W}}_{P} - {\dot{W}}_{E}} \qquad [ Equation 6 ]$$

To complete a thermodynamic cycle based on the previous section, the number of unknowns and the number of given conditions should be carefully counted such that the design parameters can be identified and optimized. Table 2 lists the number of unknowns, given conditions, and design parameters for all the cycles considered in the present invention. The integrated cycles M4, M5, and M6 have fewer parameters by two than the corresponding separate cycles M1, M2, and M3, because the circulation loop is directly coupled with the refrigeration cycle.

TABLE 2

| | | | | | | | | Thermal | | | | | |
|---|---|---|---|---|---|---|---|---|---|---|---|---|---|
| | | HTS magnets | | | | | | shields | | Current leads | | | Full |
| | | M1 | M2 | M3 | M4 | M5 | M6 | TS1 | TS2 | CL1 | CL2 | CL3 | F |
| Number of | Temperature | 6 | 9 | 12 | 3 | 6 | 9 | 6 | 3 | 6 | 10 | 6 | 13 |
| unknowns | Pressure | 6 | 9 | 10 | 3 | 6 | 7 | 6 | 3 | 7 | 11 | 5 | 11 |
| | Flow rate | 2 | 2 | 3 | 1 | 1 | 2 | 2 | 1 | 1 | 1 | 1 | 2 |
| | Sum | 14 | 20 | 25 | 7 | 13 | 18 | 14 | 7 | 14 | 22 | 12 | 26 |
| Number of | HX energy | 2 | 3 | 4 | 1 | 2 | 3 | 2 | 1 | 2 | 3 | 2 | 4 |
| given | HX ΔT | 2 | 3 | 4 | 1 | 2 | 3 | 2 | 1 | 3 | 5 | 2 | 4 |
| conditions | HX ΔP | 4 | 6 | 8 | 2 | 4 | 6 | 4 | 2 | 5 | 8 | 4 | 8 |
| | E efficiency | 1 | 2 | 2 | 1 | 2 | 2 | 1 | 1 | 1 | 2 | 2 | 4 |
| | P efficiency | 1 | 1 | 1 | | | | 1 | | 1 | 1 | | |
| | MIX energy | | | 1 | | | 1 | | | | | 1 | 2 |
| | Thermal load | 1 | 1 | 1 | 1 | 1 | 1 | 1 | 1 | | | | 2 |
| | Sum | 11 | 16 | 21 | 6 | 11 | 16 | 11 | 6 | 12 | 19 | 11 | 24 |

| | | | | | | | | | | | | |
|---|---|---|---|---|---|---|---|---|---|---|---|---|
| Number of design | 3 | 4 | 4 | 1 | 2 | 2 | 3 | 1 | 2 | 3 | 1 | 2 |
| parameters | | | | | | | | | | | | |
| Separate cycles | ◯ | ◯ | ◯ | | | | ◯ | | ◯ | ◯ | | |
| Integrated cycles | | | | ◯ | ◯ | ◯ | | ◯ | | | ◯ | ◯ |

In case of cycle M2, four design parameters are taken as the low pressure P₁, the high pressure P₂, and the intermediate pressure P₄ of the refrigeration cycle, and the inlet temperature Tᵢ of the HTS magnets. Generally, in gas cycles, the “pressure ratio” (instead of the respective pressure levels) is a dominant factor, if the working fluid behaves like an ideal gas with constant specific heat. Because of non-ideal gas behavior of helium, the elevated pressure levels may be slightly preferred for a given pressure ratio. In addition, the loss of thermodynamic efficiency due to the pressure drop in HX's may be reduced, if the operating pressure is higher. With assumption \textcircled{6}, the high pressure of the cycle is set at its upper limit (P₁=2 MPa), and other three parameters are optimized.

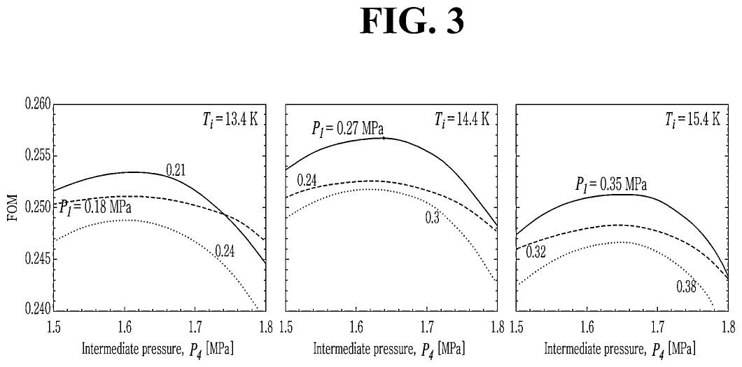

FIG. 3 shows the figure of merit (FOM) as a function of the intermediate pressure P₄ for selected values of the low pressure P₁ and the inlet temperature Tᵢ. There clearly exists a unique optimum for P₄, P₁, and Tᵢ to maximize the FOM, as indicated by a dot. In two-stage expansion, the optimal intermediate pressure is a compromise between two expanders, depending on the amount of refrigeration needed in each stage. In this cycle, the optimal P₄ is closer to the high pressure, which means that the first expander plays a minor role (at higher temperature). The optimal inlet temperature is a compromise between the temperature rise (Tₑ−Tᵢ) and the flow rate of circulating helium for the given cooling load. When Tᵢ is higher than the optimum, the temperature difference in M is smaller, but the flow rate should be larger such that more compressor power is required. In conclusion, the maximum FOM is 25.78, when the pressure levels are 2.00 MPa, 1.64 MPa, and 0.27 MPa and the inlet temperature is 14.4 K.

In cycle M4 of FIG. 2, the integrated refrigeration cycle for forced-flow cooling magnets in the nuclear fusion system according to the present invention includes a compressor C configured to compress a refrigerant, an after-cooler AC configured to cool the compressed refrigerant, a first heat exchanger HX1 configured to perform heat exchange between the high-pressure refrigerant that has passed through the after-cooler and the low-pressure refrigerant before passing through the compressor, a first expander E1 configured to expand the refrigerant that has passed through the first heat exchanger, and HTS magnets M configured to allow the expanded refrigerant to pass through internal flow paths thereof so as to be cooled to cryogenic temperatures.

In the refrigeration cycle according to the present invention, helium gas may be used as a refrigerant (working fluid) and a coolant (cooling gas) at the same time. Since helium (He) has a boiling point of less than 5 K, it exists only as a gas throughout the refrigeration cycle and does not undergo phase change. Therefore, the counterpart of the condenser in a refrigeration cycle where phase change occurs is called the after-cooler in the refrigeration cycle according to the present invention.

In cycle M5 of FIG. 2, the integrated refrigeration cycle for forced-flow cooling of the HTS magnets in the nuclear fusion system may further include a second heat exchanger HX2 configured to perform heat exchange between the refrigerant that has passed through the first expander E1 and the low-pressure refrigerant and a second expander E2 configured to expand the refrigerant that has passed through the second heat exchanger.

In the case of cycle M5, the first heat exchanger HX1, the first expander E1, the second heat exchanger HX2, and the second expander E2 are sequentially connected in series to a high-pressure refrigerant flow path. Thus, cycle M5 may be referred to as a two-stage expansion cycle.

In cycle M6 of FIG. 2, the integrated refrigeration cycle for forced-flow cooling of the HTS magnets in the nuclear fusion system according to the present invention may include a compressor C configured to compress a refrigerant, an after-cooler AC configured to cool the compressed refrigerant, a first heat exchanger HX1 configured to perform heat exchange between the high-pressure refrigerant that has passed through the after-cooler and the low-pressure refrigerant before passing through the compressor, a first expander E1 configured to expand the refrigerant that has passed through the first heat exchanger and to send the same to a low-pressure refrigerant flow path, a second heat exchanger HX2 configured to perform heat exchange between the refrigerant that has passed through the first heat exchanger and the low-pressure refrigerant, a third heat exchanger HX3 configured to perform heat exchange between the refrigerant that has passed through the second heat exchanger and the low-pressure refrigerant, a second expander E2 configured to expand the refrigerant that has passed through the third heat exchanger, and HTS magnets M configured to allow the expanded refrigerant to pass through internal flow paths thereof so as to be cooled to cryogenic temperatures.

In the refrigeration cycle according to the present invention, helium gas may be used as a refrigerant (working fluid) and a coolant (cooling gas) at the same time.

The first expander E1 may expand the refrigerant that has passed through the first heat exchanger HX1 and send the same to a flow path before being introduced into the second heat exchanger HX2 on the low-pressure refrigerant flow path. That is, the flow path connected to the outlet of the first expander E1 may be connected to a flow path between the third heat exchanger HX3 and the second heat exchanger HX2 on the low-pressure refrigerant flow path.

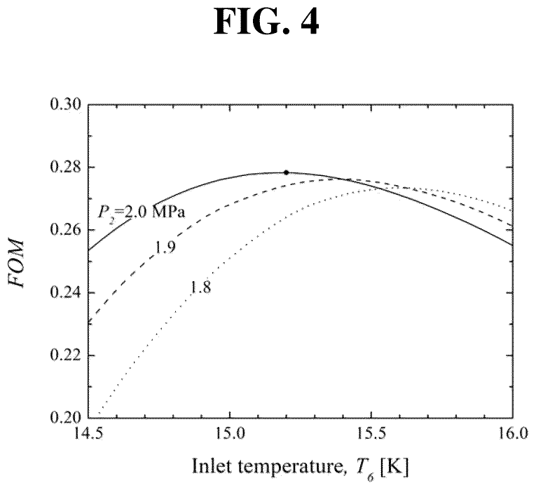

In case of cycle M6, two design parameters are taken as the high pressure P₂ and the inlet temperature T₆. FIG. 4 shows the FOM as a function of inlet temperature T₆ for some values of high pressure P₂. For a given P₂, there exists a unique optimum for T₆ to maximize the FOM, as indicated by a dot. The optimal Tᵢ is a compromise between the temperature rise (T₇−T₆) and the flow rate of circulating helium for the given cooling load, similarly to the case of cycle M2. As P₂ increases up to 2 MPa, the optimal T₆ decreases, and the maximum FOM tends to increase gradually. Again, with assumption \textcircled{6}, the high pressure of cycle is set at 2 MPa. The maximum FOM is 27.8% when the high pressure is 2.00 MPa and the inlet temperature is 15.2 K. The gain of FOM over cycle M3 is mainly due to the reduction of entropy generation at P and the low temperature HX4, as verified below.

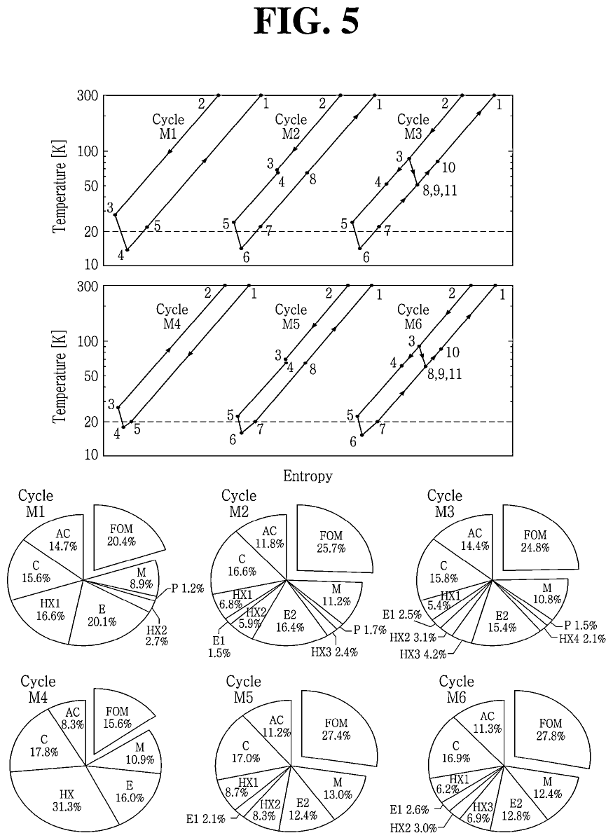

FIG. 5 shows the temperature-entropy (T-s) diagram and the exergy expenditure for six optimized M cycles. Among the standard cycles with one expander, the integrated cycle M4 is less efficient than the separate cycle M1, because the optimal low pressure is as low as 150 kPa in cycle M1, but the low pressure of cycle M4 should match with the specified inlet pressure (600 kPa) of forced flow. On the contrary, the integrated cycles with two expanders M5 and M6 are considerably more efficient than the separate cycles M2 and M3. Regarding the arrangement of two expanders, cycle M2 (series) is slightly superior to cycle M3 (parallel) in the separate configuration, but cycles M6 (parallel) and M5 (series) are almost equally efficient in the integrated configuration. Either two-stage expansion or dual-expander cycle may be recommended for the integrated design with forced-flow cooling of HTS magnets.

The pie-charts of exergy expenditure clearly verify that the greater FOM of integrated cycles is mainly due to the elimination of a pump and a cold heat exchanger. For example, the separate cycle M3 has (15.8%) and (1.5%+2.1%) irreversibility in C (compressor) and P (pump)+HX4, respectively, and the integrated cycle M6 has (16.9%) irreversibility in C (compressor) without P (pump)+HX4. It can be stated that the integration saves the irreversibility due to separate circulation by 3.6%, but requires more compressor power by 1.1%. Overall, the integrated cycle M6 has higher FOM by 3.0% than cycle M3.

### [Forced-Flow Cooling of Thermal Shield]

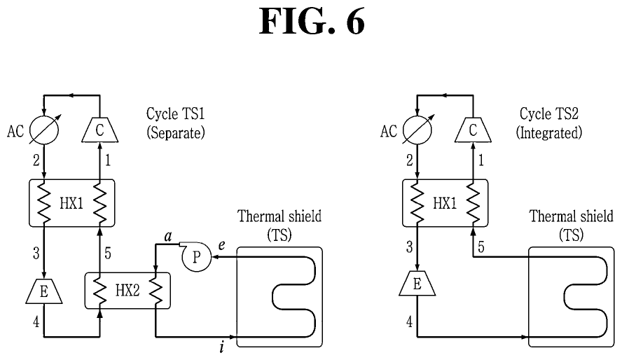

FIG. 6 shows a separate cycle TS1 and an integrated cycle TS2 for forced-flow cooling of the thermal shield TS. Since the thermal shield temperature Tis is usually higher than 80 K, two-stage expansion or dual-expander cycles are not considered here. Cycles TS1 and TS2 are optimized in the same way as cycles M1 and M4, respectively, even though the levels of refrigeration temperature are different from each other.

As shown in FIG. 6, the integrated refrigeration cycle TS2 for forced-flow cooling of the thermal shield in the nuclear fusion system according to the present invention may include a compressor C configured to compress a refrigerant, an after-cooler AC configured to cool the compressed refrigerant, a heat exchanger HX1 configured to perform heat exchange between the high-pressure refrigerant that has passed through the after-cooler and the low-pressure refrigerant before passing through the compressor, an expander E configured to expand the refrigerant that has passed through the heat exchanger, and a thermal shield TS configured to enclose HTS magnets M and to allow the refrigerant expanded by the expander E to pass through internal flow paths thereof so as to be cooled to cryogenic temperatures.

In the refrigeration cycle according to the present embodiment, helium gas may also be used simultaneously as a refrigerant (working fluid) and a coolant (coolant gas).

The HTS magnets M are not shown in FIG. 6 but are cryogenic superconductor magnets M, as shown in FIG. 1. The thermal shield TS may enclose the magnets M, which must be maintained at 20 K, to prevent cold air from escaping to the surroundings.

By the refrigeration cycle according to the present embodiment, the thermal shield TS may be cooled to be maintained at 90 to 100 K.

From Equation 3 and Equation 5, the FOM of the TS cycle is expressed as represented by Equation 7 below.

$${FOM}_{TS} = \frac{{( {\dot{W}}_{rev} )}_{TS}}{{\dot{W}}_{C} + {\dot{W}}_{P} - {\dot{W}}_{E}} = \frac{{\dot{Q}}_{TS} ( {T}_{0} / {T}_{TS} - 1 )}{{\dot{W}}_{C} + {\dot{W}}_{P} - {\dot{W}}_{E}} \qquad [ Equation 7 ]$$

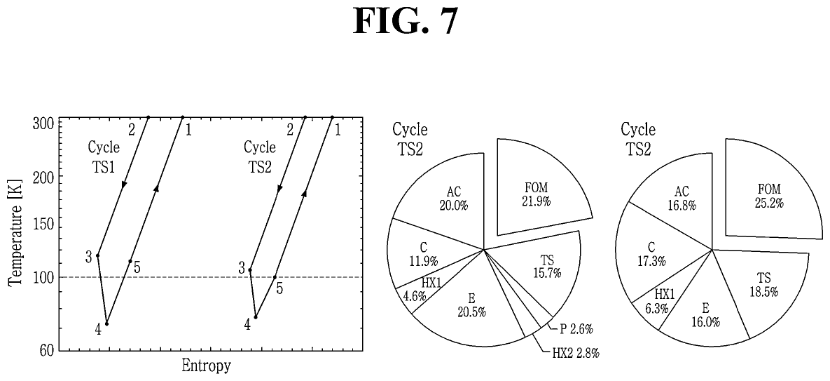

As listed in Table 2, the number of parameters to optimize is three for cycle TS1 and only one for cycle TS2. In case of cycle TS1, the optimal values are 2 MPa, 0.38 MPa, and 73.0 K for P₁, P₂, and Tₐ, respectively, and the corresponding maximum FOM is 21.9%. In case of cycle TS2, the optimum P₂ is 1.58 MPa, and the corresponding maximum FOM is 25.2%. For the optimized cycles, the temperature-entropy diagram and the exergy expenditure are shown in FIG. 7. The integrated cycle TS2 has a noticeably higher FOM than the separate cycle TS1, and the reason for better efficiency can be explained with the exergy expenditure charts. In cycle TS1, the irreversibility ratio is 2.6% and 2.8% for the pump P and the cold heat exchanger HX2, respectively, which has been eliminated in integrated cycle TS2.

### [Forced-Flow Cooling of Current Leads]

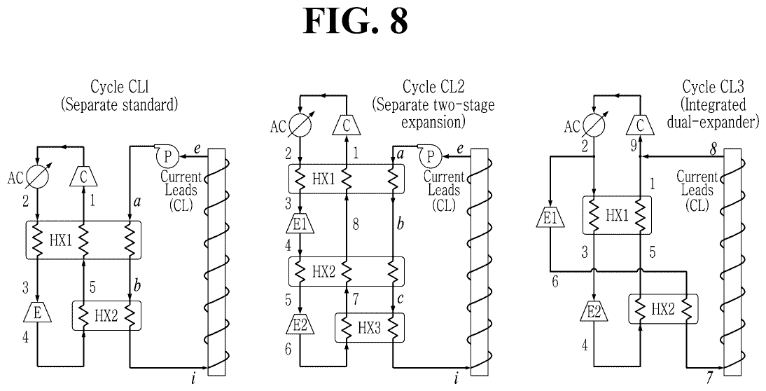

FIG. 8 shows two separate cycles CL1 and CL2, and one integrated cycle CL3 for the forced-flow cooling of current leads CL. Cycle CL1 is a standard cycle with one expander, but the circulation loop passes through both HX1 and HX2, as the warm gas returns nearly at ambient temperature. Since the inlet temperature Tᵢ should be as low as 50 K for a high current level (over 10 kA), the thermodynamic performance may be greatly improved by arranging two expanders in series, as shown in cycle CL2. Similarly to cycle M2, therefore, cycle CL2 may be called a separate two-stage expansion cycle. Similarly to cycle M3, two expanders may be arranged in parallel, but this is not included in the present invention, because the thermodynamic performance thereof is considerably poor.

The design of an integrated CL cycle is subject to more restrictions than M and TS cycles, since the return of cooling gas should be nearly at ambient temperature. The integrated versions of cycles CL1 and CL2 cannot be simply configured, because there is a pressure mismatch between the return of cooling gas (state e) and the suction of the compressor (state 1). In order to meet the requirements given in Table 1, a pump (or pre-compressor) is needed between the location of return and the exit of a warm heat exchanger (HX1), for which there is no clear advantage of the integrated cycles. Another approach is to arrange the two expanders in parallel such that one expander takes care of cooling gas and the other expander takes care of main refrigerant, shown as cycle CL3. Accordingly, cycle CL3 may be called an integrated dual-expander cycle. Other feasible configurations of the integrated cycle may be proposed, but cycle CL3 is selected and presented here, as the best among cycles the inventors have tried so far.

In the embodiment shown in FIG. 8, the integrated refrigeration cycle CL3 for forced-flow cooling of the current leads in the HTS fusion system may include a compressor C configured to compress a refrigerant, an after-cooler AC configured to cool the compressed refrigerant, a first heat exchanger HX1 configured to perform heat exchange between the high-pressure refrigerant that has passed through the after-cooler and the low-pressure refrigerant before passing through the compressor, a first expander E1 configured to expand the high-pressure refrigerant that has passed through the after-cooler and to send the same to a flow path in contact with the current leads CL, a second expander E2 configured to expand the refrigerant that has passed through the first heat exchanger, a second heat exchanger HX2 configured to perform heat exchange between the refrigerant expanded by the first expander E1 and the refrigerant expanded by the second expander E2, and current leads CL configured to allow the refrigerant that has passed through the first expander and the second heat exchanger to pass through an external flow path in contact with the surroundings thereof so as to be cooled.

Even in the refrigeration cycle according to the present embodiment, helium gas may be used as a refrigerant (working fluid) and a coolant (cooling gas) at the same time.

In the present embodiment, the second heat exchanger HX2 may perform heat exchange between the relatively high-pressure refrigerant expanded by the first expander E1 and the relatively low-pressure refrigerant expanded by the second expander E2, and send the same to the flow path in contact with the surroundings of the current leads CL.

The refrigerant flow path in contact with the current leads CL may be disposed to wrap around the current leads CL and may be connected to a low-pressure refrigerant flow path such that the refrigerant is introduced into the compressor C. The flow path wrapping around the current leads CL may be arranged to spirally wrap around the current leads CL.

The cooling load of CL is quite different from that of M and TS, as the forced flow enters at cryogenic temperature and returns nearly at ambient temperature. From Equation 3 and Equation 5, the FOM of CL cycles is expressed as follows:

$${FOM}_{TS} = \frac{{( {\dot{W}}_{rev} )}_{CL}}{{\dot{W}}_{C} + {\dot{W}}_{P} - {\dot{W}}_{E}} = \frac{{\dot{m}}_{CL} [ ( {h}_{i} - {h}_{e} ) - {T}_{0} ( {s}_{i} - {s}_{e} ) ]}{{\dot{W}}_{C} + {\dot{W}}_{P} - {\dot{W}}_{E}} \qquad [ Equation 8 ]$$

where the reversible power in the numerator is the exergy difference between the inlet and exit of cooling gas.

Cycles CL1 and CL2 are optimized similarly with cycles M1 and M2, respectively. In case of cycle CL1, P₂ is set again at 2 MPa, and the optimal P₁ is 0.36 MPa. The maximum FOM is 14.6%, which is considerably lower than the FOM of cycles M1 and TS1. The main reason is that there is a large mismatch between capacity rates in counter-flow HX1, due to the additional hot stream of cooling gas. In case of cycle CL2, the optimum P₄ and P₁ are 0.73 MPa and 0.22 MPa, respectively, and the corresponding maximum FOM is 23.1%. It should be carefully noticed that the pressure ratio of the expander E1 in cycle CL2 is much higher than that in cycle M2, because of the increased cooling load at HX1.

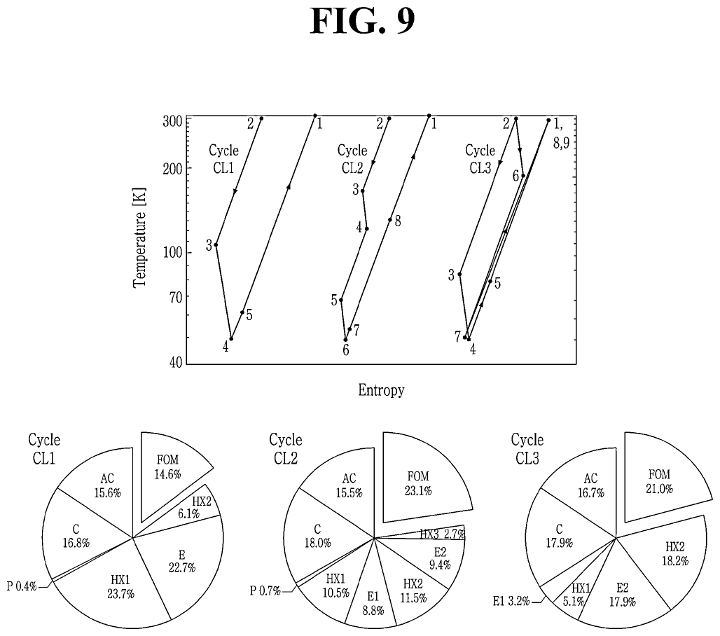

In case of integrated cycle CL3, there is only one design parameter, which is selected as P₂. Similarly with cycle M6, the FOM increases gradually, as P₂ increases up to 2 MPa. The high pressure of cycle is set at 2 MPa, and the maximum FOM is 21.0%. For the optimized CL cycles, the temperature-entropy diagram and the exergy expenditure are shown in FIG. 9. The irreversibility ratio of warm components (C+AC+P) is nearly identical for all CL cycles, but the cryogenic components (HX'S+E'S) are optimally arranged in cycle CL2, yielding the best thermodynamic performance.

From a thermodynamic point of view, the separate two-stage expansion cycle CL2 is more efficient than any integrated cycles in the forced-flow cooling of CL. On the other hand, cycle CL3 is simpler in configuration than cycle CL2, and the way of combining two expanders in parallel may be usefully applicable to the design of a fully integrated cycle, as presented below.

### [Fully Integrated Refrigeration Cycle]

Based on the results and experience of integrated design in the previous sections, a fully integrated cycle is devised to meet all the requirements of forced-flow cooling for the magnets M, the thermal shield TS, and the current leads CL at the same time. The key lesson is that an integrated cycle with two expanders (either in series or parallel) is recommended for the main refrigeration of the magnets at 20 K, and extra expanders may be effectively incorporated in parallel for the refrigeration of the thermal shield and the current leads.

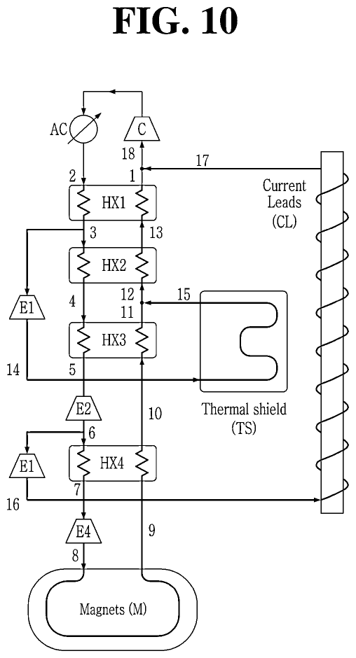

As one of the candidates, cycle F is proposed, as shown in FIG. 10. The fully integrated refrigeration cycle F for forced-flow cooling of the HTS fusion system according to the present invention includes a compressor C configured to compress a refrigerant, an after-cooler AC configured to cool the compressed refrigerant, a first heat exchanger HX1 configured to perform heat exchange between the high-pressure refrigerant that has passed through the after-cooler AC and the low-pressure refrigerant passing through the compressor C, a first expander E1 configured to expand the refrigerant that has passed through the first heat exchanger HX1 and to send the same to an internal flow path of a thermal shield, a second heat exchanger HX2 configured to perform heat exchange between the high-pressure refrigerant that has passed through the first heat exchanger HX1 and the low-pressure refrigerant, a third heat exchanger HX3 configured to perform heat exchange between the high-pressure refrigerant that has passed through the second heat exchanger HX2 and the low-pressure refrigerant, a second expander E2 configured to expand the refrigerant that has passed through the third heat exchanger HX3, a third expander E3 configured to expand the refrigerant expanded by the second expander E2 and to send the same to a flow path in contact with current leads CL, a fourth heat exchanger HX4 configured to perform heat exchange between the refrigerant expanded by the second expander E2 and the low-pressure refrigerant, a fourth expander E4 configured to expand the refrigerant that has passed through the fourth heat exchanger HX4, HTS magnets M configured to allow the refrigerant expanded by the fourth expander E4 to pass through internal flow paths thereof so as to be cooled to cryogenic temperatures, a thermal shield TS configured to allow the refrigerant expanded by the first expander E1 to pass through an internal flow path thereof so as to be cooled to cryogenic temperatures, and current leads CL configured to allow the refrigerant expanded by the third expander E3 to pass through an external flow path in contact with the surroundings thereof so as to be cooled.

Even in the fully integrated refrigeration cycle F of this embodiment, helium gas may be used as a refrigerant (working fluid) and a coolant (coolant gas) at the same time. The refrigeration cycle F according to the present embodiment may simultaneously cool the HTS magnets M, the thermal shield TS, and the current leads CL.

The low-pressure refrigerant may be compressed by the compressor C, may be cooled by the after-cooler AC, may flow sequentially through the first heat exchanger HX1, the second heat exchanger HX2, the third heat exchanger HX3, the second expander E2, the fourth heat exchanger HX4, and the fourth expander E4 on the high-pressure refrigerant flow path, and may flow through the internal flow paths of the HTS magnets M to cool the HTS magnets M.

The refrigerant that has passed through the internal flow paths of the HTS magnets M may sequentially pass through the fourth heat exchanger HX4, the third heat exchanger HX3, the second heat exchanger HX2, and the first heat exchanger HX1 on the low-pressure refrigerant flow path.

The flow path of the refrigerant that has passed through the internal flow path of the thermal shield TS may be connected to the flow path before passing through the second heat exchanger HX2 on the low-pressure refrigerant flow path. Thus, the refrigerant that has passed through the first heat exchanger HX1 and the first expander E1 in the high-pressure refrigerant flow path may cool the thermal shield TS while flowing through the internal flow path of the thermal shield TS, may flow through the second heat exchanger HX2 and the first heat exchanger HX1 on the low-pressure refrigerant flow path, and may be introduced into the compressor C.

The refrigerant flow path in contact with the current leads CL may be disposed so as to wrap around the current leads CL and may be connected to the compressor C such that the refrigerant is introduced into the compressor. Thus, some of the refrigerant expanded by the second expander E2 in the high-pressure refrigerant flow path may be expanded again by the third expander E3, and may cool the current leads CL while flowing through the refrigerant flow path disposed to wrap the current leads CL in a spiral shape. The refrigerant flow path around the current leads CL may be connected to the flow path before the compressor C in the low-pressure refrigerant flow such that the refrigerant can be compressed by the compressor C again.

The main stream of Brayton refrigeration cycle is composed of two-stage expansion (E2 and E4) for M at the cold end, just like cycle M5. Two extra expanders E1 and E3 are added for TS and CL, respectively. This arrangement is regarded as parallel, because E1 and E2 have almost the same pressure ratio and E3 and E4 have almost the same pressure ratio as well. The flow rates of E1 and E3 should be determined so as to meet the cooling requirements of the thermal shield and the current leads, respectively.

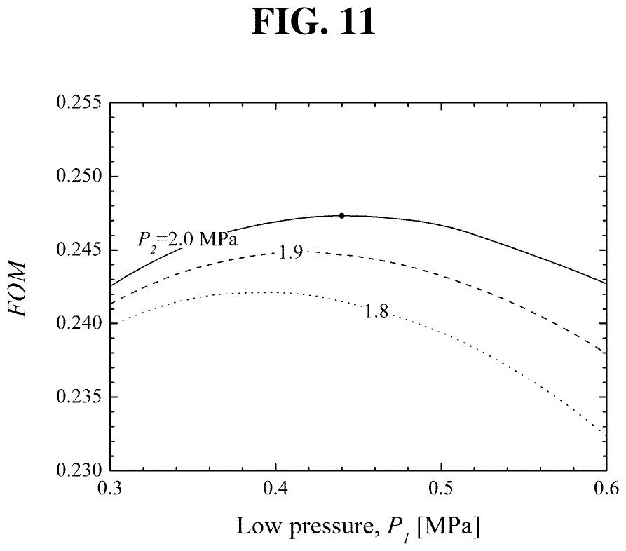

For the optimization of cycle F, the number of design parameters is two, as listed in Table 2. FIG. 11 shows the FOM as a function of low pressure (P₁) for various values of high pressure (P₂). For a given P₂, there exists a unique optimum for P₁ to maximize the FOM. As P₂ increases, the corresponding maximum of the FOM increases gradually, and the high pressure of cycle is set at 2 MPa according to assumption \textcircled{6}. The optimum P₁ is 0.44 MPa, and the overall maximum of the FOM is 24.8%.

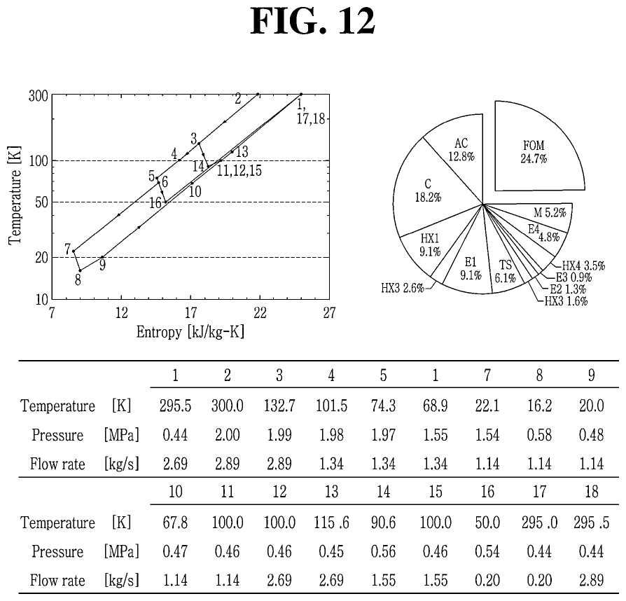

Full details of the optimized cycle F are shown in FIG. 12. The first diverted flow to E1 is supplied for forced-flow cooling of TS at 100 K, and the second diverted flow to E3 is supplied for forced-flow cooling of CL at 50 K. Through two-stage expansion, the main stream reaches down to 16.2 K for forced-flow cooling of M at 20 K. The temperature, pressure, and flow rate at each point are listed for the optimized cycle, and it can be confirmed therefrom that all assumptions and the refrigeration requirements in Table 1 are correctly satisfied.

Finally, the value and limitation of the present invention should be mentioned. It is verified that the FOM of newly proposed cycles (24 to 28%) is generally in the same range with the state-of-the-art Brayton refrigerators. The M cycles are comparable with the recently installed 20 K refrigerator for target moderator in ESS, and the TS cycles are comparable with the commercial product for sub-cooling of liquid nitrogen at 65 to 75 K. It is difficult to find existing refrigerators to compare with the CL cycles, but a hydrogen liquefier (from 300 K to 20 K) with helium Brayton cycles under construction may be approximately comparable in cycle configuration. Large-scale refrigeration at about 20 K has not been widely demanded so far, but is clearly emerging for high-field HTS magnet applications, such as in nuclear fusion. The modification and optimization of the Brayton refrigeration cycle is an important thermodynamic task to realize gas cooling by forced flow, and the present invention is a pioneering effort towards the development of practical systems. Whereas some important technical issues (such as operation scheme or thermal stability) are not considered in this thermodynamic study, more realistic cooling requirements should be incorporated in next steps along with the advance of HTS fusion technology.

Thermodynamic optimization is executed for the modified Brayton refrigeration cycles that can be applied to the forced-flow cooling of future HTS fusion system. In order to meet the cooling requirement not only for the HTS magnets at 20 K, but also for the thermal shield at 100 K, and for the current leads at 50 to 295 K, a variety of modified Brayton cycles are selected and optimized. As an index of thermodynamic performance, the figure of merit (FOM) is defined as the ratio of reversible work to actual work for refrigeration. The integration of refrigeration cycle and circulation loop of forced-flow cooling is newly proposed, and it is quantitatively verified that the integrated design can significantly eliminating increase the FOM by the circulating pump and the cold heat exchanger. Full details of cycle data may be presented for the next steps to practical development of large-scale refrigeration systems at 20 K.

As is apparent from the above description, in the modified Brayton refrigeration cycles for forced-flow cooling of the HTS fusion system according to the present invention, gaseous helium is used as a refrigerant and a coolant at the same time, thereby providing an integrated cooling cycle that simultaneously and efficiently cools the HTS magnets, the heat shield, and the current leads.

In addition, easy and simple operation is achieved without cryogenic pumps or blowers for forced flow.

Although an embodiment of the present invention has been described above, it will be apparent to a person having ordinary skill in the art to which the present invention pertains that the present invention can be variously modified and altered through addition, change, deletion, or supplement of components without departing from the idea of the present invention recited in the following claims and that such modifications and alterations fall within the scope of right of the present invention.

What is claimed is:

1. An integrated refrigeration cycle for forced-flow cooling of a high-temperature superconductor (HTS) fusion system, the integrated refrigeration cycle comprising:
a compressor configured to compress a refrigerant;
an after-cooler configured to cool the compressed refrigerant;
a first heat exchanger configured to perform heat exchange between the high-pressure refrigerant that has passed through the after-cooler and the low-pressure refrigerant before passing through the compressor;
a first expander configured to expand the refrigerant that has passed through the first heat exchanger and to send the same to an internal flow path of a thermal shield;
a second heat exchanger configured to perform heat exchange between the high-pressure refrigerant that has passed through the first heat exchanger and the low-pressure refrigerant;
a third heat exchanger configured to perform heat exchange between the high-pressure refrigerant that has passed through the second heat exchanger and the low-pressure refrigerant;
a second expander configured to expand the refrigerant that has passed through the third heat exchanger;
a third expander configured to expand the refrigerant expanded by the second expander and to send the same to a flow path in contact with a current lead;
a fourth heat exchanger configured to perform heat exchange between the refrigerant expanded by the second expander and the low-pressure refrigerant;
a fourth expander configured to expand the refrigerant that has passed through the fourth heat exchanger;
an HTS magnet configured to allow the refrigerant expanded by the fourth expander to pass through an internal flow path thereof so as to be cooled to a cryogenic temperature;
a thermal shield configured to allow the refrigerant expanded by the first expander to pass through an internal flow path thereof so as to be cooled to the cryogenic temperature; and
a current lead configured to allow the refrigerant expanded by the third expander to pass through an external flow path in contact with surroundings thereof so as to be cooled.

2. The integrated refrigeration cycle according to claim 1, wherein helium gas is used as the refrigerant and a coolant at the same time.

3. The integrated refrigeration cycle according to claim 1, wherein the refrigerant that has passed through the internal flow path of the HTS magnet sequentially passes through the fourth heat exchanger, the third heat exchanger, the second heat exchanger, and the first heat exchanger on a low-pressure refrigerant flow path.

4. The integrated refrigeration cycle according to claim 2, wherein the refrigerant that has passed through the internal flow path of the HTS magnet sequentially passes through the fourth heat exchanger, the third heat exchanger, the second heat exchanger, and the first heat exchanger on a low-pressure refrigerant flow path.

5. The integrated refrigeration cycle according to claim 3, wherein a flow path of the refrigerant that has passed through the internal flow path of the thermal shield is connected to a flow path before passing through the second heat exchanger on the low-pressure refrigerant flow path.

6. The integrated refrigeration cycle according to claim 4, wherein a flow path of the refrigerant that has passed through the internal flow path of the thermal shield is connected to a flow path before passing through the second heat exchanger on the low-pressure refrigerant flow path.

7. The integrated refrigeration cycle according to claim 3, wherein the refrigerant flow path in contact with the current lead is disposed so as to wrap around the current lead and is connected to the compressor such that the refrigerant is introduced into the compressor.

8. The integrated refrigeration cycle according to claim 4, wherein the refrigerant flow path in contact with the current lead is disposed so as to wrap around the current lead and is connected to the compressor such that the refrigerant is introduced into the compressor.
